(19) United States
(12) Patent Application Publication
(10) Pub. No.: US 2013/0129868 A1
(43) Pub. Date: May 23, 2013

(54) Protein Precipitate Comprising Minerals and Method for the Manufacture Thereof

(71) Applicants: Ibrahim Gülseren, Guelph (CA); Melina Corredig, Guelph (CA); Peter S. Given, JR., Ridgefield, CT (US); Yuan Fang, Cortlandt Manor, NY (US)

(72) Inventors: Ibrahim Gülseren, Guelph (CA); Melina Corredig, Guelph (CA); Peter S. Given, JR., Ridgefield, CT (US); Yuan Fang, Cortlandt Manor, NY (US)

(73) Assignees: University of Guelph, Guelph (CA); PepsiCo., Inc., Purchase, NY (US)

(21) Appl. No.: 13/301,886

(22) Filed: Nov. 22, 2011

(51) Int. Cl. A23J 3/08; A23L 1/30; A23L 1/304; A23L 1/305; A23L 2/52; A23L 2/66

(52) U.S. Cl. 426/74; 426/648; 426/590; 426/583

(57) ABSTRACT

Edible precipitate is disclosed binding one or more minerals that are stable in acidic aqueous systems. The precipitate may be utilized in acidic food products. The precipitate comprises at least one mineral and a layer around the at least one mineral wherein the layer comprises protein precipitate. Methods of producing the precipitate are also disclosed.

### TECHNICAL FIELD OF THE INVENTION

The present invention relates to the field of supplementing food products with mineral nutrients.

### BACKGROUND OF THE INVENTION

Minerals are essential to the function of organs and the maintenance of a healthy body. Certain minerals have been identified as playing important roles in biological processes, including, for example, calcium, magnesium, potassium, sodium, iodine, phosphorous, chlorine, molybdenum, manganese, iron, copper, zinc, and selenium. Unfortunately people worldwide are affected by various mineral deficiencies. The effect of each mineral deficiency varies depending on which mineral(s) is deficient.

It would be desirable to provide edible compositions suitable for use in food products, which compositions incorporate one or more mineral compounds, such as, for example zinc and/or iron. It also would be desirable to provide food products incorporating such edible compositions. At least certain of the embodiments of the new compositions disclosed below can reduce or eliminate the unpleasant taste or odor of the one or more incorporated mineral compounds and easily release the mineral in a controlled manner when used as an ingredient in a food product for consumption by a human or animal. At least certain of the embodiments of the new compositions disclosed below provide mineral compounds in a stable form for use in aqueous systems such as beverages or other food products. Additional features and advantages of some or all of the food products disclosed here will be apparent to those who are skilled in food technology given the benefit of the following summary and description of exemplary, non-limiting examples.

### SUMMARY

Aspects of the invention are directed to delivery systems for mineral compounds, which may be incorporated into food products such as, for example, an acidic food product. By surrounding a mineral compound in protein precipitate, one or more negative effects (e.g., off flavor, unpleasant aroma, etc.) of the mineral compound in the food product can be reduced or eliminated.

In one aspect, a method of forming an aqueous dispersion of protein precipitate comprises providing a mineral and protein solution comprising a soluble protein and at least one mineral, and adding to the mineral and protein solution a precipitation liquid, e.g., one or a mixture of precipitation liquids with or without water and/or other ingredients, to form an aqueous dispersion of precipitate binding the at least one mineral. In other embodiments the soluble protein is selected from whey protein, egg protein, soy protein, lupine protein, rice protein, pea protein, wheat protein, and combinations of any of them. In some embodiments the at least one mineral is selected from calcium, magnesium, potassium, sodium, iodine, phosphorous, chlorine, molybdenum, manganese, iron, copper, zinc, selenium, and combinations of any of them.

In certain embodiments the soluble protein consists essentially of whey protein, e.g. whey protein isolate. In certain embodiments the at least one mineral consists essentially of iron, zinc, e.g., zinc chloride, or a combination of zinc and iron. In some embodiments the soluble protein consists essentially of whey protein and the at least one mineral consists essentially of zinc, iron, or a combination of zinc and iron. In certain embodiments the precipitation liquid comprises a salt solution or an alcohol liquid. In certain embodiments the precipitation liquid is an alcohol liquid comprising methanol, ethanol, propanol, butanol, isopropyl alcohol, or a combination of any of them. In certain embodiments the precipitation liquid consists essentially of ethanol. Optionally, most or all of any alcohol content of the precipitation liquid is removed, then or at any point in the production of a food product, in which the mineral binding protein precipitate is used as an ingredient. In some embodiments the precipitation liquid is a salt solution comprising sodium sulphate, ammonium sulphate, or a combination of sodium sulphate and ammonium sulphate. In certain embodiments the precipitation liquid consists essentially of sodium sulphate. In certain embodiments the precipitation liquid consists essentially of ethanol, the soluble protein consists essentially of whey protein, such as, for example, whey protein isolate, and the at least one mineral consists essentially of zinc, such as, for example, zinc chloride. In certain embodiments the precipitation liquid consists essentially of sodium sulphate, the soluble protein consists essentially of whey protein, such as, for example, whey protein isolate, and the at least one mineral consists essentially of zinc, such as, for example, zinc chloride. In certain embodiments the aqueous dispersion of precipitate is combined with at least one other edible ingredient to form a food product. The food product may be a beverage product, snack product, or other food product, and in some embodiments the food product has a pH of 1.0 to 5.5. In certain embodiments at least 80 wt. %, or even 90 wt. %, 95 wt. %, or 99 wt. % of the mineral is bound by the precipitate. In some embodiments the protein precipitate includes at least 75% of the soluble protein originally present in the mineral and protein solution. In certain embodiments the mineral and protein solution is free of visible aggregates prior to precipitation. In certain embodiments the pH of the mineral and protein solution is adjusted before or after adding the precipitation liquid. In certain embodiments, the mineral and protein solution is adjusted to a pH of between 8 and 10. In certain embodiments the volume of precipitation liquid added to the mineral and protein solution is less than 3 times the volume of the mineral and protein solution. In certain embodiments at least a majority of the protein precipitate have a particle size less than 1 μm, e.g., between 10 and 500 nm. In certain embodiments the precipitation liquid consists essentially of ethanol, the protein consists essentially of whey protein, and the mineral consists essentially of zinc, iron, or a combination of zinc and iron. In certain embodiments the precipitation liquid consists essentially of sodium sulphate, the protein consists essentially of whey protein, and the mineral consists essentially of zinc, iron, or a combination of zinc and iron.

In a second aspect, an aqueous dispersion of precipitate is provided, wherein the precipitate is prepared as disclosed above.

In a third aspect, a food product comprising protein precipitate is provided. The precipitate binds at least one mineral and is prepared by the method disclosed above. In certain embodiments the food product is a beverage product, snack product, or other food product, and the precipitate is dispersed in the food product, such as a beverage, and in certain embodiments the food product has a pH between 1.0 and 5.5.

In a fourth aspect, a beverage product comprising an aqueous dispersion of protein precipitate wherein the protein precipitate binds at least one mineral consisting essentially of zinc, iron, or a combination of zinc and iron.

These and other aspects, advantages and features of the present invention here disclosed will become apparent through reference to the following detailed description. Furthermore, it is to be understood that the features of the various embodiments described here are not mutually exclusive and exist in various combinations and permutations in other embodiments.

### BRIEF DESCRIPTION OF THE DRAWINGS

In the drawings, like reference characters generally refer to the same parts throughout the different views. Also, the drawing is not necessarily to scale, emphasis instead generally being placed upon illustrating the principles of the invention. In the following description, various embodiments of the present invention are described with reference to the following drawing, in which:

FIG. 1 depicts a processing flowchart for a first embodiment of the present invention.

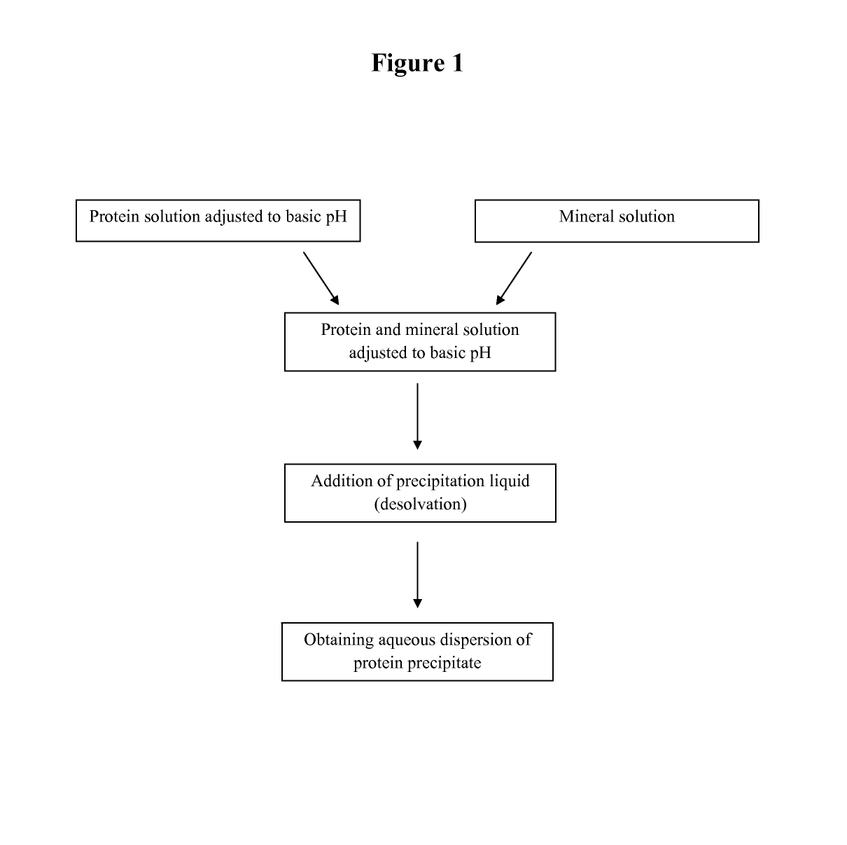

FIG. 2 depicts a processing flowchart for a second embodiment of the present invention.

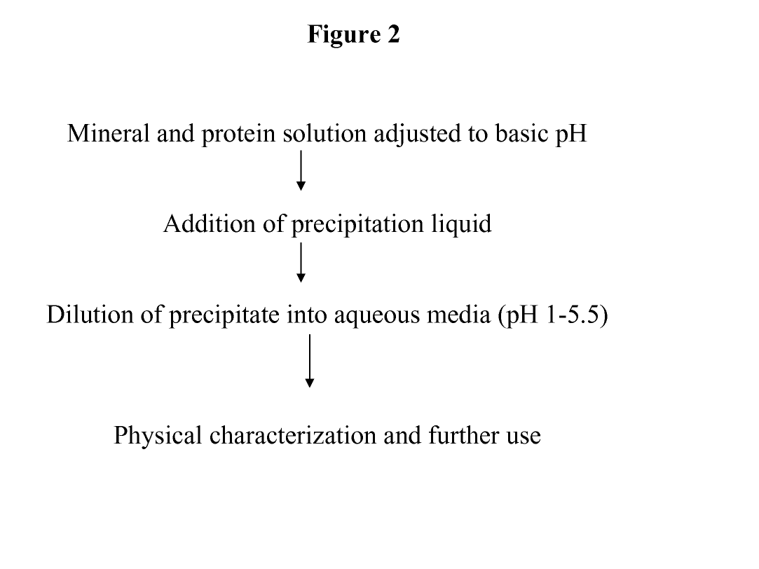

### DETAILED DESCRIPTION OF THE INVENTION

Various examples and embodiments of the inventive subject matter disclosed here are possible and will be apparent to the person of ordinary skill in the art, given the benefit of this disclosure. In this disclosure reference to “certain embodiments”, “certain exemplary embodiments”, and similar phrases, all mean that those embodiments are merely non-limiting examples or versions of the inventive subject matter disclosed and that there likely are alternative embodiments which are not excluded from the scope of the disclosure. Unless otherwise indicated or unless otherwise clear from the context in which it is described, alternative elements or features in the embodiments and examples below and in the Summary above are interchangeable with each other. That is, an element described in one example may be interchanged or substituted for one or more corresponding elements described in another example. Similarly, optional or non-essential features disclosed in connection with a particular embodiment or example should be understood to be disclosed for use in any other embodiment of the disclosed subject matter. More generally, the elements of the examples should be understood to be disclosed generally for use with other aspects and examples of the dispersions, food products, and methods disclosed here. A reference to a component or ingredient being operative, i.e., able to perform one or more functions, tasks and/or operations or the like, is intended to mean that it can perform the expressly recited function(s), task(s) and/or operation(s) in at least certain embodiments, and may well be operative to perform also one or more other functions, tasks and/or operations. While this disclosure includes specific examples, including presently preferred modes or embodiments, those skilled in the art will appreciate that there are numerous variations and modifications within the spirit and scope of the invention as set forth in the appended claims. Each word and phrase used in the claims is intended to include all its dictionary meanings consistent with its usage in this disclosure and/or with its technical and industry usage in any relevant technology area. Indefinite articles, such as “a,” and “an” and the definite article “the” and other such words and phrases are used in the claims in the usual and traditional way in patents, to mean “at least one” or “one or more.” The word “comprising” is used in the claims to have its traditional, open-ended meaning, that is, to mean that the product or process defined by the claim may optionally also have additional features, elements, etc. beyond those expressly recited.

Aspects of the invention relate to protein precipitate for mineral compounds. The disclosed protein precipitate provides a stable composition suitable for inclusion in at least certain food products. That is, in some embodiments, the precipitate, or the disclosed dispersion, is stable for shelf-storage, for use in making food products, and/or for shelf-storage when included in food products, e.g. acidic food products. In certain embodiments the precipitate reduces or eliminates the unpleasant taste and odor of the bound mineral compounds, such as calcium, magnesium, potassium, sodium, iodine, phosphorous, chlorine, molybdenum, manganese, iron, copper, zinc, or selenium. In at least certain embodiments the precipitate can also serve to control the release of the mineral compounds upon ingestion. The precipitate may, for example, be incorporated into a food product associated with health benefits, e.g., fruit juice, sports drinks, etc., to provide enhanced nutritional value. Additionally, the precipitate may in certain embodiments be incorporated into carbonated soft drinks. In some embodiments the resulting food products can be appealing to the consumer, as well as being sufficiently stable for an adequate shelf life.

In certain embodiments, the precipitate is provided in an aqueous dispersion. As used here, an “aqueous dispersion” means particles or precipitate distributed within a medium of liquid water, e.g., as a suspension, a colloid, an emulsion, a sol, a slurry, etc. In some embodiments the medium of liquid water may be pure water or may be a mixture of water with one or more other ingredients, e.g., at least one water-miscible solvent, such as, for example, ethanol or other alcohols, propylene glycol, glycerin, etc. In certain embodiments, there may be a substantial concentration of water-miscible solvent in the aqueous dispersion of the microcapsules, such as, between 1 wt. % and 20 wt. %, for example 5 wt. %, 10 wt. %, or 15 wt. %. In other embodiments, the precipitate is incorporated as an ingredient in a food product, e.g., a beverage product, a snack product, or other food product. For example, the precipitate may be diluted into a food product where the concentration of water-miscible solvent is negligible.

“Protein precipitate” or “precipitate”, as used here interchangeably, means discrete particles binding a quantity of one or more mineral compounds enveloped by an interface layer in a manner that separates the mineral compound from the environment surrounding the particles. In certain embodiments, there may be clearly identifiable discrete clusters (e.g. agglomerates) of the aforementioned precipitate. “Precipitate” is used to refer to one or more precipitates.

As used here interchangeably, “mineral” or “mineral compound” can be any mineral in any suitable nutritional form, such as for example, an ionic form, a salt, a metal, a colloid, a complex, or a compound. For example, in the case of the mineral zinc, it should be understood to include, e.g., zinc sulphate, zinc chloride, zinc gluconate, zinc oxide, and/or zinc stearate. Additionally, the “mineral” may be any suitable oxidation state. For example, in the case of the mineral iron, it should be understood to include, e.g., ferrous and ferric forms of the mineral. A “mineral solution” refers to a solution having one or more minerals, in one or various forms. Additionally, in some embodiments a “mineral solution” may have additional ingredients in addition to the one or more minerals.

As used here “protein” refers to a polymer where, at least predominately, amino acids are arranged in a chain and joined together by peptide bonds between the carboxyl and amino groups of adjacent amino acid residues. Also, a “protein” may include one or a mixture of different proteins. Typically, the protein contains at least 10 amino acid residues. The protein employed in accordance with the present invention can be, for instance, an intact naturally occurring protein, a protein hydrolysate or a synthesised protein. Further, as used here, a “globular protein” refers to a protein having a close to spherical tertiary structure wherein the molecule's apolar (hydrophobic) amino acids are oriented towards the molecule's interior and the molecule's polar (hydrophilic) amino acids are oriented outwards, allowing dipole-dipole interactions with water. A protein's polar side groups tend to exert attractive forces on other polar groups of atoms within the protein molecule, or on polar molecules in the protein's surroundings. Similarly, non-polar side groups tend to exert attractive forces (of a different nature) on other non-polar side chains within the protein. The shape assumed by a globular protein molecule tends to maximize both types of attractive forces, whereby non-polar side chains “point” inward and interact with one another and polar side chains are oriented outward such that they are exposed to adjacent polar water molecules. A “protein solution” refers to a solution having one or more protein(s), in one or various forms. Additionally, in some embodiments a “protein solution” may have additional ingredients in addition to the one or more proteins.

As used here, a “precipitation liquid” means one or a mixture of liquids with or without water and/or other ingredients that can cause precipitation of the mineral and protein solution. In some embodiments the precipitation liquid is a salt solution. In certain embodiments the salt solution is a saturated salt solution. In some embodiments the precipitation liquid is an alcohol liquid and the alcohol is any organic compound suitable for a room temperature alcohol liquid, in which a hydroxyl functional group is bound to a carbon atom. In certain embodiments the alcohol liquid may comprise alcohol molecules diluted within the alcohol liquid. In alternative embodiments the alcohol liquid may be a pure alcohol. The alcohol liquid may comprise, for example, various amounts of alcohol molecules, including 50 wt. %, 60 wt. %, 70 wt. %, 80 wt. %, 90 wt. %, or 100 wt. % alcohol molecules. For example, an “alcohol liquid” consisting essentially of ethanol could have approximately 95 wt. % ethanol molecules and 5 wt. % water molecules. Denatured ethanol has a higher percentage of ethanol molecules, but typically includes benzene or other inedible content. Embodiments of the aqueous dispersions of protein precipitate disclosed here that are prepared using denatured ethanol in the alcohol liquid or as the alcohol liquid may not be suitable for use in some embodiments of the disclosed food product.

In certain embodiments a protein solution is prepared comprising a globular protein.

In certain embodiments the protein is a soluble protein, such as, for example, an essentially soluble protein. As used here, a “soluble” protein is a protein that is soluble up to 10 wt. % in deionized water at room temperature. In at least certain embodiments the protein is a soluble protein selected from, for example, whey protein, egg protein, lupine protein, soy protein, rice protein, pea protein, wheat protein, and combinations of any of them. In certain embodiments the soluble protein may consist essentially of whey protein. The whey protein may be present in a variety for forms, such as, for example, whey protein isolate, whey protein concentrate, or whey protein hydrolysate. In certain embodiments, the whey protein comprises β-lactoglobulin, a-lactalbumin, and/or serum albumin. In other embodiments the soluble protein consists essentially of whey protein isolate. The aqueous solution may comprise, for example, 1 to 10 wt. % protein in water or in water with other solvents, optionally with other ingredients. In certain embodiments, a bacteriostatic agent, such as, for example, sodium azide, may be added to the protein solution to stop bacteria from reproducing. In certain embodiments the pH of the protein solution is adjusted, for example, the pH may be adjusted to between pH 8 and 10.

In certain embodiments a mineral solution is provided. In certain embodiments an aqueous solution is prepared comprising at least one mineral. The aqueous solution may comprise, for example, between 0.6 and 1.8 wt. % mineral in water or in water with other solvents, optionally with other ingredients. In some embodiments the aqueous solution may comprise, for example, not more than the weight percentage of mineral to reach the maximum solubility limit of such mineral in water or in water with other solvents, optionally with other ingredients, at alkaline pH. In certain embodiments the at least one mineral is selected from calcium, magnesium, potassium, sodium, iodine, phosphorous, chlorine, molybdenum, manganese, iron, copper, zinc, selenium, and combinations of any of them. The at least one mineral may consist essentially of, for example, zinc. Alternatively, the at least one mineral may consist essentially of, for example, iron. In at least certain embodiments the mineral may consist essentially of zinc and iron in combination. Zinc may be, for example, zinc sulphate, zinc chloride, zinc gluconate, zinc oxide, zinc stearate or combinations of any of them. Iron may be, for example, iron chloride. In certain embodiments, the mineral consists essentially of zinc chloride. In alternative embodiments, the mineral consists essentially of iron chloride.

It is understood that when forming a protein or mineral solution the protein or mineral may dissociate to an extent when added to the solvent. For example, when zinc chloride is added to a solution of water, the solution will comprise zinc ions, chloride ions, and zinc chloride molecules. As used here, a solution comprising a specific weight percentage of protein or mineral is referring to a specific weight percentage of the unassociated form of the protein or mineral, i.e., the form of the protein or mineral when it is added to the solvent.

In at least certain embodiments the soluble protein consists essentially of whey protein, such as, for example whey protein isolate, and the at least one mineral consists essentially of zinc, such as, for example, zinc chloride. In certain other embodiments the soluble protein consists essentially of whey protein, such as, for example whey protein isolate, and the at least one mineral consists essentially of iron, such as, for example, iron chloride. In certain alternative embodiments the soluble protein consists essentially of whey protein, such as, for example whey protein isolate, and the at least one mineral consists essentially of zinc and iron in combination, such as for example, zinc chloride and iron chloride.

In certain embodiments a mineral and protein solution is provided comprising a soluble protein and at least one mineral. In alternative embodiments a mineral solution is combined with a protein solution to form a mineral and protein solution. In certain embodiments the final concentration of soluble protein in the mineral and protein solution is, at least 2 wt. %, or is between 2 wt. % and 10 wt. %, or is 5 wt. %. In certain embodiments the final concentration of mineral in the mineral and protein solution is at least 0.065 wt. %, or is between 0.065 wt. % and 0.65 wt. % or is between 1 mM and 10 mM. In certain embodiments the mineral and protein solution pH is adjusted and in certain embodiments the mineral and protein solution is adjusted to a pH of, for example, between 8 and 10. In certain embodiments the mineral and protein solution is free of visible aggregates. Visible aggregates are those that can be seen under normal lighting and operating conditions by the human eye.

In certain embodiments additional components may be included in the mineral and protein solution. Additional components in the mineral and protein solution may be, for example, incorporated upon formation of the protein precipitate, or may remain dispersed within the solution. In certain embodiments HCl, NaOH, sodium benzoate, sugars and colors may be included in the mineral and protein solution.

In certain embodiments a precipitation liquid is added to the mineral and protein solution. In some embodiments the addition of the liquid causes the mineral and protein solution to desolvate thereby forming protein precipitate. In certain embodiments the precipitation liquid is added to the mineral and protein solution at a rate of 1 ml.min⁻¹ or in some embodiments, at a rate of between 0.5 and 2 ml.min⁻¹. In certain embodiments the volume of precipitation liquid added to the mineral and protein solution is less than 3 times the volume of the mineral and protein solution. In certain embodiments the precipitation liquid is a salt solution or an alcohol liquid. In some embodiments the precipitation liquid is a salt solution comprising sodium sulphate, ammonium sulphate, or a combination of sodium sulphate and ammonium sulphate. In certain embodiments the salt solution is a saturated salt solution. In some embodiments the precipitation liquid is an alcohol liquid comprising ethanol, methanol, propanol, butanol, isopropyl alcohol, or a combination of any of them. In some embodiments the precipitation liquid consists essentially of ethanol molecules. In certain embodiments the precipitation liquid may be 50 wt. %, 60 wt. %, 70 wt. %, 80 wt. %, 90 wt. %, or 100 wt. % ethanol molecules. In certain alternative embodiments the mineral and protein solution may be heated, for example, in addition to, or as an alternative to, precipitation, to assist in forming the protein precipitate.

In some embodiments all or a certain amount of any alcohol content of the precipitation liquid is removed from the aqueous dispersion of protein precipitate. The precipitation liquid may be removed, for example, by spray drying, freeze drying, drum drying, or bed drying. In certain embodiments the alcohol content is removed before the aqueous dispersion of protein precipitate is incorporated into a food product. In alternative embodiments any alcohol content is removed during incorporation or after incorporation of the aqueous dispersion of protein precipitate into the food product.

In at least certain embodiments the soluble protein consists essentially of whey protein, such as, for example whey protein isolate, the at least one mineral consists essentially of zinc, such as, for example, zinc chloride, and the precipitation liquid consists essentially of ethanol. In certain embodiments the soluble protein consists essentially of whey protein, such as, for example whey protein isolate, the at least one mineral consists essentially of iron, such as, for example, iron chloride, and the precipitation liquid consists essentially of ethanol. In certain alternative embodiments the soluble protein consists essentially of whey protein, such as, for example whey protein isolate, the at least one mineral consists essentially of zinc and iron in combination, such as for example, zinc chloride and iron chloride, and the precipitation liquid consists essentially of ethanol.

In at least certain embodiments the soluble protein consists essentially of whey protein, such as, for example whey protein isolate, the at least one mineral consists essentially of zinc, such as, for example, zinc chloride, and the precipitation liquid consists essentially of sodium sulphate. In certain embodiments the soluble protein consists essentially of whey protein, such as, for example whey protein isolate, the at least one mineral consists essentially of iron, such as, for example, iron chloride, and the precipitation liquid consists essentially of sodium sulphate. In certain alternative embodiments the soluble protein consists essentially of whey protein, such as, for example whey protein isolate, the at least one mineral consists essentially of zinc and iron in combination, such as for example, zinc chloride and iron chloride, and the precipitation liquid consists essentially of sodium sulphate.

In certain embodiments, the protein precipitate has a particle size within the range of, for example, less than 1 μm, or between 10 and 500 nm, or alternatively less than 100 nm, or between 10 and 100 nm. The “particle size” refers to the measurement at the largest dimension of the aggregate. For example, if the protein precipitate is essentially globular in nature, the measurement of the largest dimension will be the average diameter, e.g., the volume weighted average diameter. In some embodiments the average diameter of the protein precipitate may vary depending on, for example, the amount of mineral incorporated within the precipitate. The particle size of the precipitate may be measured by, for example, dynamic light scattering techniques.

In certain embodiments, the protein precipitate binds, for example, between 0.5 and 10 mg/L, or between 0.8 and 6 mg/L, or 1.6 mg/L of the at least one mineral. The “binding” of at least one mineral means the precipitate reacts with, or otherwise incorporates, the mineral into the precipitate. The mineral may be bound by the precipitate in any way known by those of skill in the art, including, but not limited to, Van der Waal forces, mechanical entrapment, ionic bonding, etc. In certain embodiments the amount of mineral of the mineral and protein solution bound by the protein precipitate may be, for example, between 30 and 100 wt. %, between 75 and 100 wt. %, at least 80%, or in some embodiments between 95 and 100 wt. %. Any unbound mineral may, in certain examples, remain dispersed within the aqueous dispersion. The binding efficiency of the precipitate may be measured by, for example, ion chromatography techniques. In some embodiments the incorporation efficiency may vary, for example, based on the initial concentration of the mineral and on the amount of precipitation liquid added to form the precipitate.

In certain embodiments the protein precipitate includes at least 75% of the soluble protein originally present in the mineral and protein solution. In some embodiments the protein precipitate includes at least 30%, at least 40%, at least 50%, at least 60%, at least 70%, at least 80%, or at least 90% of the soluble protein originally present in the mineral and protein solution. Any non-included amount of soluble protein may, in certain examples, remain dispersed within the aqueous dispersion.

In certain embodiments, the aqueous dispersion of the present invention may contain other dispersed components in addition to the precipitate. In certain embodiments, the dispersion contains less than 20 wt. % of one or more dispersed edible components, including the dispersed precipitate.

In certain embodiments, the precipitate is not substantially additionally stabilized, for example by substantial gelling or substantial hardening of the precipitate. In certain alternative embodiments the protein precipitate may be cross-linked, for example, by utilizing a cross-linking agent, for example, gluteraldehyde. In an alternative embodiment the protein precipitate may be cross-linked by forming disulphide bridges between the protein molecules.

In certain embodiments, the aqueous dispersion of precipitate is maintained as an aqueous dispersion. In alternative embodiments, the aqueous dispersion of precipitate is, for example, spray dried, vacuum freeze dried, conventionally freeze dried, drum dried, bed dried, desiccant dried, or cryogenic dried. If maintained as an aqueous dispersion, in certain embodiments, the aqueous dispersion of precipitate is treated to protect from microbiological growth. In certain embodiments, the aqueous dispersion of precipitate is, for example, pasteurized, aseptically packaged, treated with chemical preservatives, for example, sodium hexameta phosphate (SHMP), EDTA, calcium sorbate, potassium sorbate, sodium citrate, potassium citrate, calcium benzoate, sodium benzoate, potassium benzoate, sodium chloride, sulphur dioxide, nisin or natamycin, treated with acids, for example, phosphoric acid, succinic acid, tartaric acid, HCl, citric acid, or acetic acid, or carbonated. In other embodiments, the aqueous dispersion of precipitate has minimized contact with air during production, is pasteurized after production, and is stored in a refrigerator with limited contact with light.

In certain embodiments, the precipitate is dispersed in a food product. In certain embodiments, the aqueous dispersion of precipitate contains the dispersed precipitate in a concentration of, for example, between 1 and 10 wt. %, or in some embodiments between 1 and 5 wt. % of the continuous aqueous phase. In certain embodiments, the aqueous dispersion contains a limited amount of precipitate and the continuous aqueous phase represents the bulk, for example, at least 1 wt. %, between 1 and 5 wt. %, or between 1 and 2 wt. % of the aqueous dispersion. In certain embodiments at least one edible ingredient is combined with the aqueous dispersion of precipitate.

In certain embodiments, the aqueous dispersion of precipitate is a pourable concentrate that can be used to deliver the precipitate to e.g. food products. In accordance with this embodiment, the aqueous dispersion contains between 5 and 20 wt. % of the precipitate and between 10 and 20 wt. % of the continuous aqueous phase.

In certain embodiments, a concentrated precipitate composition is prepared containing, for example, at least 1 wt. %, at least 5 wt. %, or at least 10 wt. % of dispersed precipitate. In certain embodiments the concentrated precipitate composition is combined with water and, in other embodiments, other constituents to produce a food product. In certain embodiments the combining of the concentrated precipitate composition with water and other constituents produces a dilution factor (final volume/volume of the concentrated precipitate composition), for example, of at least 10, or alternatively, of at least 100. In certain embodiments the dilution factor does not exceed 20.

In certain embodiments, a desired amount of mineral compound in the form of the above-described precipitate is included in a food product. The amount of precipitate, and hence the amount of mineral compound included in the food product may vary depending on the application and desired taste characteristics of the food product. The precipitate may be added to the food product in any number of ways, as would be appreciated by those of ordinary skill in the art given the benefit of this disclosure. In certain embodiments, the precipitate is sufficiently mixed, stirred, sprayed, or incorporated in some other way in the food product to provide a substantially uniform distribution, for example a stable dispersion. For example, mixing should be accomplished such that the precipitate is not destroyed. The mixer(s) can be selected for a specific application based, at least in part, on the type and amount of ingredients used, the viscosity of the ingredients used, the amount of product to be produced, the flow rate, and the sensitivity of ingredients, such as the precipitate, to shear forces or shear stress.

When included in an acidic food product, the precipitate may provide a stable dispersion of mineral compound over the shelf life of the food product. Factors that may effect the shelf-life of the precipitate include the level of processing the product undergoes, the type of packaging, and the materials used for packaging the product. Additional factors that may affect the shelf life of the product include, for example, the nature of the base formula (e.g., an acidic beverage sweetened with sugar has a longer shelf-life than an acidic beverage sweetened with aspartame) and environmental conditions (e.g., exposure to high temperatures and sunlight is deleterious to ready-to-drink beverages).

In certain embodiments, the food product is a beverage product. In certain embodiments, the beverage products include ready-to-drink beverages, beverage concentrates, syrups, shelf-stable beverages, refrigerated beverages, frozen beverages, and the like. In some embodiments, the beverage product is acidic, e.g. having a pH within the range below pH 5.0, in certain embodiments, a pH value within the range of between pH 1.0 and pH 4.5, or in certain embodiments, a pH value within the range of between pH 1.5 and pH 3.8. Beverage products include, but are not limited to, e.g., carbonated and non-carbonated soft drinks, fountain beverages, liquid concentrates, fruit juice and fruit juice-flavored drinks, sports drinks, energy drinks, fortified/enhanced water drinks, soy drinks, vegetable drinks, grain-based drinks (e.g. malt beverages), fermented drinks (e.g., yogurt and kefir) coffee beverages, tea beverages, dairy beverages, and mixtures thereof. Exemplary fruit juice sources include citrus fruit, e.g. orange, grapefruit, lemon and lime, berry, e.g. cranberry, raspberry, blueberry and strawberry, apple, grape, pineapple, prune, pear, peach, cherry, mango, and pomegranate. Beverage products include bottle, can, and carton products and fountain syrup applications.

Certain embodiments of other food products include fermented food products, yogurt, sour cream, cheese, salsa, ranch dip, fruit sauces, fruit jellies, fruit jams, fruit preserves, and the like. In certain embodiments, the food product is acidic, e.g. having a pH value within the range below pH 5.0, in certain embodiments, a pH value within the range of between pH 1.0 and pH 4.5, or in certain embodiments, a pH value within the range of between pH 1.5 and pH 3.8.

The food product may optionally include other additional ingredients. In certain embodiments, additional ingredients may include, for example, vitamins, minerals, sweeteners, water-soluble flavorants, colorings, thickeners, emulsifiers, acidulants, electrolytes, antifoaming agents, proteins, carbohydrates, preservatives, water-miscible flavorants, edible particulates, and mixtures thereof. In certain embodiments, other ingredients are also contemplated. In some embodiments, the ingredients can be added at various points during processing, including before or after pasteurization, and before or after addition of the precipitate.

In at least certain embodiments, food products disclosed here may be pasteurized. The pasteurization process may include, for example, ultra high temperature (UHT) treatment and/or high temperature-short time (HTST) treatment. The UHT treatment includes subjecting the food or beverage product to high temperatures, such as by direct steam injection or steam infusion, or by indirect heating in a heat exchanger. Generally, after the product is pasteurized, the product can be cooled as required by the particular product composition/configuration and/or the package filling application. For example, in one embodiment, the food or beverage product is subjected to heating to between 185° F. (85° C.) and 250° F. (121° C.) for a short period of time, for example, 1 to 60 seconds, then cooled quickly to 36° F. (2.2° C.)+/10° F. (5° C.) for refrigerated products, to ambient temperature for shelf stable or refrigerated products, and to 185° F. (85° C.)+/−10° F. (5° C.) for hot-fill applications for shelf-stable products. The pasteurization process is typically conducted in a closed system, so as not to expose the food product to atmosphere or other possible sources of contamination. In alternative embodiments, other pasteurization or sterilization techniques may also be useful, such as, for example, aseptic or retort processing. In addition, multiple pasteurization processes may be carried out in series or parallel, as necessitated by the food product or ingredients.

Food products may, in addition, be post processed. In some embodiments, post processing is typically carried out following addition of the precipitate. Post processing can include, for example, cooling the product solution and filling it into container for packaging and shipping. In certain embodiments, post processing may also include deaeration of the food product to less than 4.0 ppm oxygen, less than 2.0 ppm, or less than 1.0 ppm oxygen. In alternative embodiments, deaeration and other post processing tasks may be carried out prior to processing, prior to pasteurization, prior to mixing with the precipitate and/or at the same time as adding the precipitate. In addition, in certain embodiments, an inert gas (e.g., nitrogen or argon) headspace may be maintained during the intermediary processing of the product and final packaging. Additionally/alternatively, an oxygen or UV radiation barriers and/or oxygen scavengers could be used in the final packaging.

The following examples are specific embodiments of the present invention, but are not intended to limit it.

### EXAMPLES

### Example 1

Using a commercial whey protein isolate (WPI) sample (Power Pro, Land O'Lakes Dairy Proteins Group, St. Paul, Minn., USA), protein solutions were prepared at a pH of 9.0 in MilliQ water. 0.02 wt. % sodium azide was added to all protein solutions as a bacteriostatic (Fisher Scientific, Fair Lawn, N.J., USA). The pH of the solution was adjusted to pH 9.0 using concentrated NaOH (2 M). The pH adjusted protein solution was kept refrigerated overnight, and was then filtered through 0.45 μm PVDF syringe filters (Millipore, Millex HV, Fisher Scientific, Mississauga, ON, Canada). A zinc stock solution was prepared utilizing 0.25 M ZnCl₂ (>99.995%, Sigma-Aldrich, Catalog No: 429430). The filtered protein solution and ZnCl₂ solutions were mixed together to provide a WPI and ZnCl₂ solution, with each having a concentration of 5 wt. % and 1-10 mM, respectively. As the addition of the zinc acidifies the protein solution, the pH of the WPI and zinc solution was adjusted rapidly to pH 9.0 and the solution was stirred for 60 min to ensure the complete dissolution of the mineral salt.

The protein sample was used as received without any further purification. After obtaining the pH adjusted WPI and zinc solution, 2 mL of the solution was desolvated using ethanol. The ethanol was added at a rate of 1 ml.min⁻¹ and the volume of ethanol added ranged from between 0 to 3 times the volume of the protein solution. Upon completion of the desolvation process, an aqueous dispersion of protein precipitate existed.

### Example 2

Using a commercial whey protein isolate (WPI) sample (Power Pro, Land O'Lakes Dairy Proteins Group, St. Paul, Minn., USA), protein solutions were prepared at a pH of 9.0 in MilliQ water. 0.02 wt. % sodium azide was added to all protein solutions as a bacteriostatic (Fisher Scientific, Fair Lawn, N.J., USA). The pH of the solution was adjusted to pH 9.0 using concentrated NaOH (2 M). The pH adjusted protein solution was kept refrigerated overnight, and was then filtered through 0.45 μm PVDF syringe filters (Millipore, Millex HV, Fisher Scientific, Mississauga, ON, Canada). An iron stock solution was prepared utilizing 0.25 M FeCl₃ (>99.9% on trace metals basis, Sigma-Aldrich, Catalog No: 701122). The filtered protein solution and FeCl₃ solutions were mixed together to provide a WPI and FeCl₃ solution, with each having a concentration of 5 wt. % and 1-5 mM, respectively. As the addition of the iron acidifies the protein solution, the pH was of the WPI and iron solution was adjusted rapidly to pH 9.0 and the solution was stirred for 60 min to ensure the complete dissolution of the mineral salt. The protein sample was used as received without any further purification. After obtaining the pH adjusted WPI and iron solution, 2 mL of the solution was desolvated using ethanol. The ethanol was added at a rate of 1 ml.min⁻¹ and the volume of ethanol added ranged from between 0 to 3 times the volume of the protein solution. Upon completion of the desolvation process, an aqueous dispersion of protein precipitate existed.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. A method of forming an aqueous dispersion of protein precipitate comprising:
providing a mineral and protein solution comprising soluble protein and at least one mineral, and
adding to the mineral and protein solution a precipitation liquid to form an aqueous dispersion of protein precipitate binding the at least one mineral.

2. The method of forming an aqueous dispersion of protein precipitate of claim 1 wherein the at least one mineral is selected from calcium, magnesium, potassium, sodium, iodine, phosphorous, chlorine, molybdenum, manganese, iron, copper, zinc, selenium and combinations of any of them.

3. The method of forming an aqueous dispersion of protein precipitate of claim 1 wherein the at least one mineral consists essentially of zinc, iron, or a combination of zinc and iron.

4. The method of forming an aqueous dispersion of protein precipitate of claim 1 wherein the at least one mineral consists essentially of zinc chloride.

5. The method of forming an aqueous dispersion of protein precipitate of claim 1 wherein the soluble protein is selected from whey protein, egg protein, soy protein, lupine protein, rice protein, pea protein, wheat protein, and combinations of any of them.

6. The method of forming an aqueous dispersion of protein precipitate of claim 1 wherein the soluble protein consists essentially of whey protein isolate.

7. The method of forming an aqueous dispersion of protein precipitate of claim 1 wherein the soluble protein consists essentially of whey protein and the at least one mineral consists essentially of zinc, iron, or a combination of zinc and iron.

8. The method of forming an aqueous dispersion of protein precipitate of claim 1, further comprising combining the aqueous dispersion of protein precipitate with at least one edible ingredient.

9. The method of forming an aqueous dispersion of protein precipitate of claim 8 wherein the food product is a beverage.

10. The method of forming an aqueous dispersion of protein precipitate of claim 8 wherein the food product has a pH of 1.0 to 5.5.

11. The method of forming an aqueous dispersion of protein precipitate of claim 1 wherein at least 80 wt. % of the at least one mineral is bound by the protein precipitate.

12. The method of forming an aqueous dispersion of protein precipitate of claim 1 wherein the protein precipitate includes at least 75% of the soluble protein originally present in the mineral and protein solution.

13. The method of forming an aqueous dispersion of protein precipitate of claim 1, further comprising adjusting the pH of the mineral and protein solution.

14. The method of forming an aqueous dispersion of protein precipitate of claim 13 wherein the pH of the mineral and protein solution is adjusted to a pH value between pH 8 and pH 10 prior to adding the precipitation liquid.

15. The method of forming an aqueous dispersion of protein precipitate of claim 1 wherein the precipitation liquid comprises an alcohol liquid or a salt solution.

16. The method of forming an aqueous dispersion of protein precipitate of claim 15 wherein the precipitation liquid is an alcohol liquid comprising methanol, ethanol, propanol, butanol, isopropyl alcohol, or a combination of any of them.

17. The method of forming an aqueous dispersion of protein precipitate of claim 15 wherein the precipitation liquid is a salt solution comprising ammonium sulphate, sodium sulphate, or a combination of ammonium sulphate and sodium sulphate.

18. The method of forming an aqueous dispersion of protein precipitate of claim 1 wherein the precipitation liquid consists essentially of ethanol.

19. The method of forming an aqueous dispersion of protein precipitate of claim 1 wherein the precipitation liquid consists essentially of sodium sulphate.

20. The method of forming an aqueous dispersion of protein precipitate of claim 1 wherein the volume of precipitation liquid added to the mineral and protein solution is less than 3 times the volume of the mineral and protein solution.

21. The method of forming an aqueous dispersion of protein precipitate of claim 1 wherein at least a majority of the protein precipitate has a particle size between 10 and 500 nm.

22. The method of forming an aqueous dispersion of protein precipitate of claim 1 wherein the precipitation liquid consists essentially of ethanol, the soluble protein consists essentially of whey protein, and the at least one mineral consists essentially of zinc, iron or a combination of zinc and iron.

23. The method of forming an aqueous dispersion of protein precipitate of claim 1 wherein the precipitation liquid consists essentially of sodium sulphate, the soluble protein consists essentially of whey protein, and the at least one mineral consists essentially of zinc, iron or a combination of zinc and iron.

24. The method of forming an aqueous dispersion of protein precipitate of claim 1 further comprising removing any alcohol content of the precipitation liquid from the aqueous dispersion of protein precipitate.

25. The method of forming an aqueous dispersion of protein precipitate of claim 1 wherein the mineral and protein solution is free of visible precipitate.

26. An aqueous dispersion of protein precipitate wherein the protein precipitate binds at least one mineral and is prepared by a method comprising:
providing a mineral and protein solution comprising a soluble protein and at least one mineral, and
adding to the mineral and protein solution a precipitation liquid to form an aqueous dispersion of protein precipitate binding the at least one mineral.

27. The aqueous dispersion of protein precipitate of claim 26 wherein the precipitation liquid consists essentially of ethanol, the soluble protein consists essentially of whey protein isolate, and the at least one mineral consists essentially of zinc, iron, or a combination of zinc and iron.

28. The aqueous dispersion of protein precipitate of claim 26 wherein the precipitation liquid consists essentially of sodium sulphate, the soluble protein consists essentially of whey protein isolate, and the at least one mineral consists essentially of zinc, iron, or a combination of zinc and iron.

29. A food product comprising protein precipitate wherein the protein precipitate binds at least one mineral and is prepared by a method comprising:
providing a mineral and protein solution comprising a soluble protein and at least one mineral, and
adding to the mineral and protein solution a precipitation liquid to form an aqueous dispersion of protein precipitate binding the at least one mineral.

30. The food product of claim 29 wherein the food product is a beverage having a pH of between pH 1.0 and pH 5.5 and the protein precipitate is dispersed in the beverage.

31. A beverage product comprising an aqueous dispersion of protein precipitate wherein the protein precipitate binds at least one mineral consisting essentially of zinc, iron, or a combination of zinc and iron.
